(19) United States
(12) Patent Application Publication
(10) Pub. No.: US 2018/0286295 A1
(43) Pub. Date: Oct. 4, 2018

(54) LIGHT EMITTING DIODE ASSEMBLY

(71) Applicant: GE Lighting Solutions, LLC, East Cleveland, OH (US)

(72) Inventor: Eden DUBUC, Lachine (CA)

(21) Appl. No.: 15/471,129

(22) Filed: Mar. 28, 2017

(51) Int. Cl. G09F 13/22; F21V 5/00; F21V 17/12; F21V 19/00; F21V 3/00

(52) U.S. Cl. CPC G09F 13/22; F21V 5/007; F21Y 2115/10; F21V 19/003; F21V 3/00; F21V 17/12

(57) ABSTRACT

A light source assembly for use with a sign is provided. The light source assembly includes a set of light emitting diodes disposed on a substrate. The light source assembly includes a pair of brackets configured to secure the substrate. Furthermore, at least one bracket of the pair of brackets includes a set of lenses where each lens overlaps with a light emitting diode of the set of light emitting diodes, and the substrate is mounted perpendicularly to a backing surface of the sign.

### TECHNICAL FIELD

The present disclosure relates to light emitting diodes. More particularly, the present disclosure relates to a light emitting diode assembly.

### BACKGROUND

Light emitting diodes (LEDs) are ubiquitous. With recent advances in manufacturing technologies, LEDs are now cost-effective, and they are being included in a wide variety of products that typically did not use LEDs. For example, one such product is outdoor luminaires that typically used incandescent lamps. Another class of products that is seeing increase LED adoption is signage that typically used neon lamps.

In the latter case, several issues exist in assembling the LEDs. For example, one issue is the non-uniformity in luminance inherently obtained by placing discrete LED blocks along a surface. Moreover, the wiring needed to connect a large number of LEDs can be cumbersome, which drives up the cost of a sign and of its assembly.

### SUMMARY

The embodiments featured herein help solve or mitigate the above noted issues as well as other issues known in the art. With the embodiments described herein, it is possible to make and install signage that provides uniformly distributed luminance. Moreover, the embodiments offer significant reduction in costs because cumbersome wiring of LEDs is obviated, in some embodiments, with the use of a flexible strip printed circuit board to mount the LEDs and deliver power to them.

One embodiment provides a light source assembly for use with a sign. The light source assembly includes a plurality of light emitting diodes disposed on a substrate. The light source assembly further includes a pair of brackets configured to secure the substrate. Furthermore, at least one bracket of the pair of brackets includes a set of lenses where each lens overlaps with a light emitting diode of the plurality of light emitting diodes, and the substrate is mounted perpendicularly to a backing surface of the sign.

Another embodiment provides a light source assembly for use with a sign. The light source assembly includes a pair of brackets securing a substrate onto which there is mounted a set of light emitting diodes. At least one bracket of the pair of brackets includes a lens configured to redirect light from a light emitting diode of the set of light emitting diodes towards a diffusive surface of the sign disposed perpendicularly relative to the pair of brackets.

Another embodiment provides a method for assembling a set of light emitting diodes in a sigh. The method includes mounting a set of light emitting diodes on a substrate. The method further includes securing the substrate with a set of brackets such that the substrate is perpendicular to a backing surface of the sign. Furthermore, at least one bracket in the set of brackets includes a lens configured to redirect light from at least one light emitting diode of the set of light emitting diodes to a diffusive surface of the sign disposed perpendicularly relative to the substrate.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A illustrates a light source assembly in accordance with several aspects described herein.

FIG. 1B illustrates a partial view of a light source assembly in accordance with several aspects described herein.

FIG. 2A illustrates a side view of a light source assembly in accordance with several aspects described herein.

FIG. 2B illustrates another side view of a light source assembly in accordance with several aspects described herein.

FIG. 3 illustrates the flow chart of a method in accordance with an embodiment described herein.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

The exemplary embodiments described herein can be used to form a light source for signage applications. For example, some of the embodiments feature the use of a LED strip perpendicular to the signage backing. Further some of the embodiments feature a clip that is used to install the LED strip in place but that also includes a lens that redirects the light from sideway to the illumination face of the signage, i.e., in a direction normal to the LED strip.

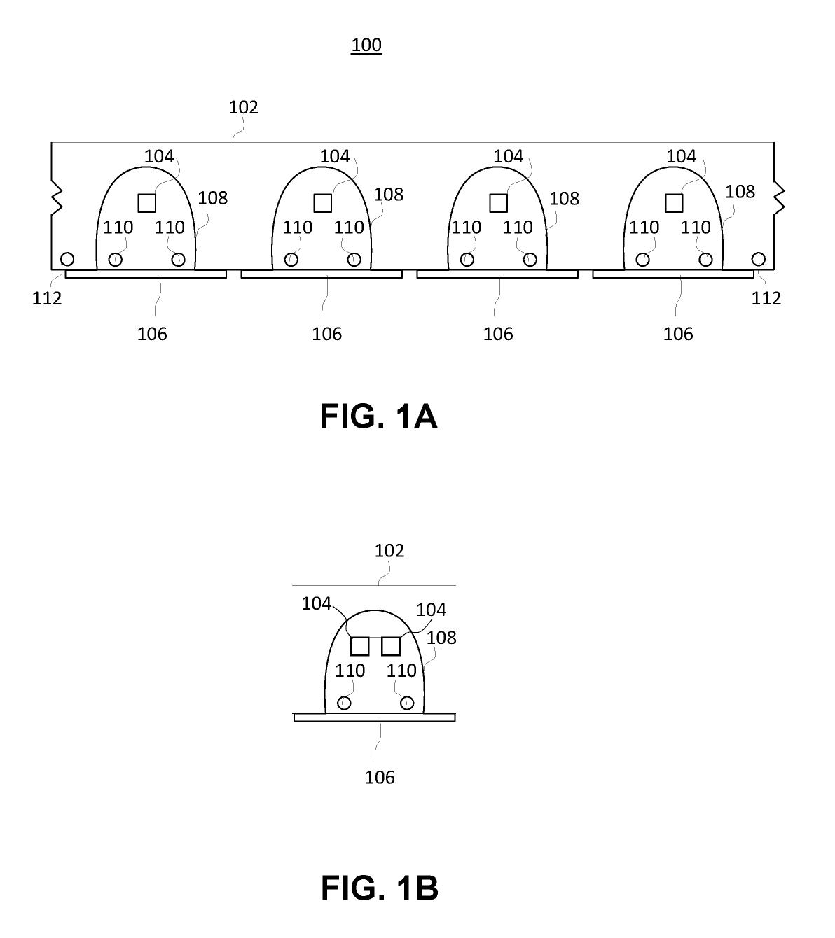

FIG. 1A illustrates a light source assembly 100 according to an embodiment. The light source assembly 100 includes a substrate 102, which can a be a double sided flex strip printed circuit board (PCB) that is configured to mount LEDs. For example, a set of LEDs 104 can be mounted on the substrate 102 at predetermined pitch. While only one row of LEDs in shown, one of skill in the arts that additional rows of LEDs 104 can be mounted on the substrate 102 without departing from the scope of the present disclosure.

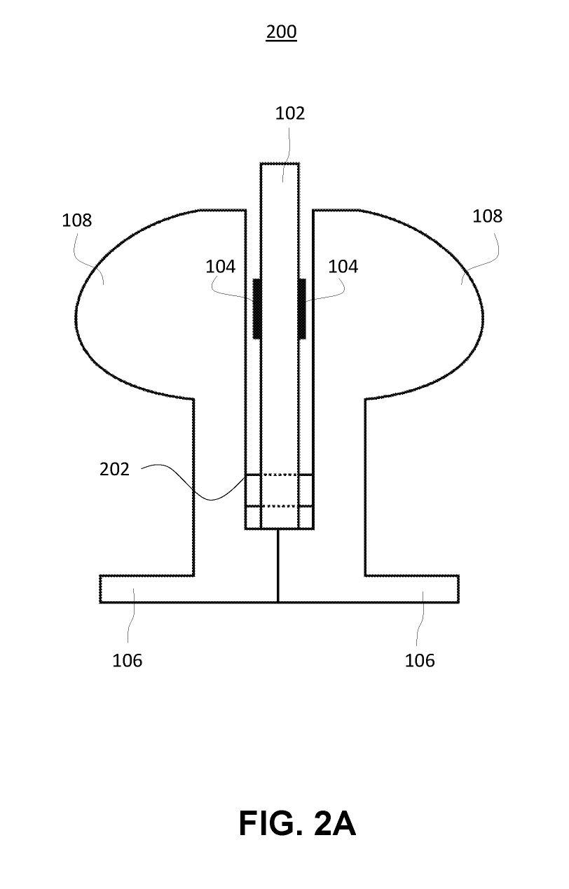

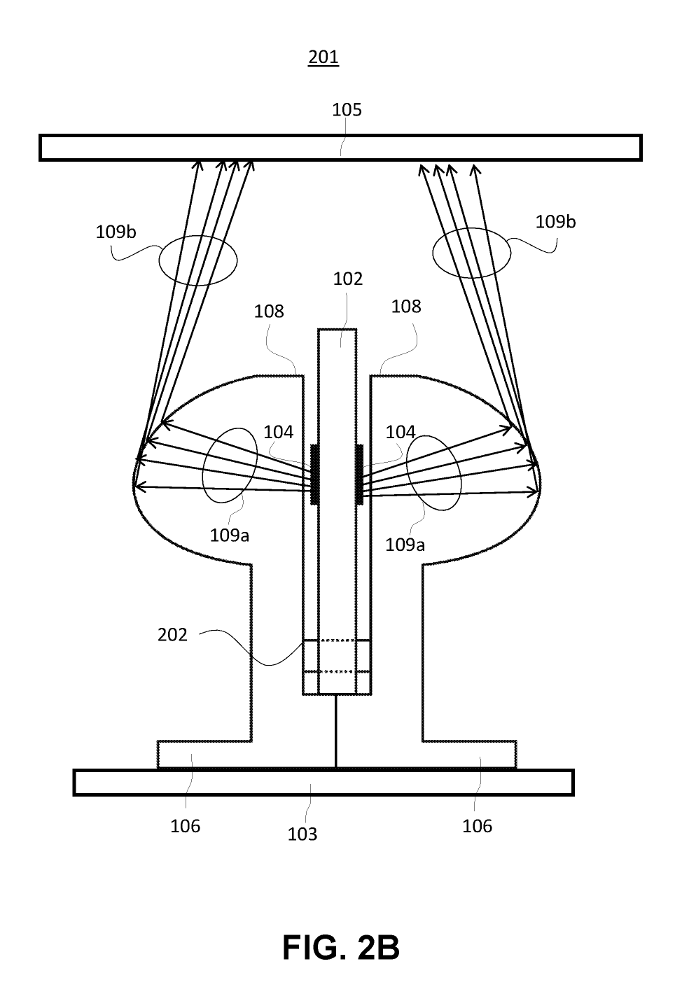

The substrate 102 can be secured with a set brackets 106 for the purpose of subsequently mounting the substrate 102 (assembled with the brackets 106) on a wall to form an LED-based sign. Each bracket 106 or at least one of the bracket 106 can include a lens 108 that overlaps with an LED 104. The lens 108 can be made of a transparent plastic part that has a radius of curvature that provides a specific lensing effect, as shall be described in greater detail below with respect to FIG. 2B.

The lens 108 may be made of a polymer. For example, the lens 108 can be made from either one of polycarbonate (PC), poly-methyl-methacrylate (PMMA), or silicone. In general, an entire bracket 106 (not just the lens 108) may be made from either one of the aforementioned materials. Moreover, the substrate 102 may generally be a PCB and is not limited to a flexible strip. For example, and not by limitation, the substrate 102 may be a FPCB, a FR4, a CEM1, or an MCPBC.

A bracket 106 on the front of the substrate 102 can be fixed to the substrate 102 and to another bracket 106 on the back of the substrate 102 via at least one hole 110, which can be threaded so as to allow a screw or the like to be used to secure the parts together. Alternatively, the holes 110 can be used to fasten the brackets 106 and the substrate 102 together using a fastener. The substrate 102 can further include additional holes 112 that are placed on its periphery in order to facilitate further securing of the light source assembly 100 on a surface, such as that of a wall, for example. In yet other embodiments, the bracket 106 can be snapped onto the substrate, thus providing an easy mechanism for securing the bracket 106 onto the substrate 102.

FIG. 1B illustrates another embodiment of the light source assembly 100, where a lens 108 is used for covering more two LEDs. As such, in the light source assembly 100, fewer brackets 106 may be used to provide a desired lensing effect for the plurality of LEDs 104. While only two LEDs 104 per single bracket 106 are shown in FIG. 1A, generally, other embodiments may include more than two LEDs 104 per single bracket 106. Such embodiments are advantageous when a signage in which the light source assembly 100 is used is small or shallow; specifically, such an arrangement may lower the cost of the assembly, in addition to allowing more light to be directed sideways.

FIG. 2A illustrates a cross-sectional view 200 of the light source assembly 100. As previously mentioned, the substrate 102 can include LEDs 104 disposed on both of its sides, and two brackets 106 can be used to hold and secure the substrate 102 via, a set of screws 202 inserted in the holes 110. In some embodiments, in addition to the substrate 102, the set of brackets 106 can also be flexible. In yet other embodiments, the brackets 106 and the substrate 102 can be rigid parts.

In yet other embodiment, a plurality of LEDs 104 may be mounted on a single side of the substrate 102, in which case the brackets 106 are disposed only on the side of the substrate 102 onto which the plurality of LEDs 104 are mounted. These alternate embodiments may be advantageous in reducing costs, but also when the density and/or the distance to a diffusive surface of a sign including the light source assembly 100 are critical.

FIG. 2B illustrates a cross-sectional view 201 of the light source assembly 100 when it is mounted on a backing surface 103 and below a diffusive surface 105 to form a sign, for example. As shown in FIG. 2B, the plurality of LEDs 104 emit light in a direction that is substantially normal to their emissive surface, i.e. to the left and to the right of the page, as depicted by the light rays 109a. In the light source assembly 100, because each bracket 106 includes a lens 108, the rays 109a may be re-directed to the diffusive surface 105, as depicted by the rays 109b. In one implementation, a lens 108 of any one of the brackets 106 in the assembly may be a refractive lens. In other implementations, the lens 108 may be a total internal reflection (TIR) lens, or it may be a reflector. Furthermore, different beam patterns may be obtained by varying the shape of the lens 108, and as such, the present disclosure does not limit the shape of the lens 108 to the shape shown in the drawings.

The embodiments provide an arrangement wherein one or more brackets 106 and the substrate 102 are disposed perpendicularly to the backing surface 103. As such, depending on the properties of the lens 108 of the one or more brackets 106, the light emitted from the LEDs 104 mounted to the substrate 102 may be redirected towards the diffusive surface 105, which is also disposed perpendicularly with respect to substrate 102 and the one or more brackets 106. In some embodiments, the lens 108 may redirect more than 60% of the light emitted from the LEDs 104 towards the diffusive surface 105.

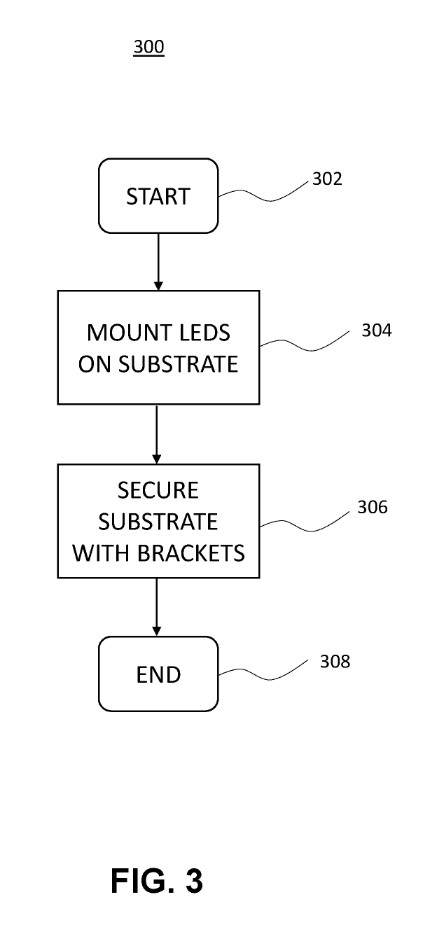

Having set forth a structural description of several exemplary embodiments, a method 300 of assembly consistent with these embodiments is now described with respect to FIG. 3. The method 300 can begin at step 302 and it can include mounting the LEDs 104 on the substrate 102. This can be achieved via a soldering process, for example. The method 300 further includes securing the substrate 102 with the brackets 106 by either fastening or screwing the parts together as shown in FIG. 2A. The method can then end at step 308.

Generally, an embodiment can be a light source assembly that includes a plurality of light emitting diodes disposed on a flexible substrate. The light source assembly can include a pair of brackets configured to secure the flexible substrate, wherein at least one of the pair of brackets includes a set of lenses where each lens overlaps with a light emitting diode of the plurality of light emitting diodes.

The flexible substrate may be a printed circuit board. Further, each bracket of the pair of bracket can include at least one whole configured for housing or for inserting a screw or a fastener in order to clip the pair of brackets together. When mounted together in that fashion, the brackets form a “T” clip.

One of the brackets (or both) can include a portion made of transparent plastic, where the portion is configured (i.e., shaped) in such a way to direct light from a light emitting diode in a direction that is substantially normal to the flexible substrate. In the case where both brackets include lenses, there can be mounted two flexible substrates, each disposed back to back so that there can be a set of light emitting diodes on both sides of the sign.

Another embodiment can be a light source assembly that includes a pair of brackets securing a substrate onto which there is mounted a set of light emitting diodes, where at least one bracket of the pair of brackets includes a lens configured to redirect light from a light emitting diode of the set of light emitting diodes.

The substrate can be a flexible substrate, such as a flexible printed circuit board. As in the previous embodiment, one or both of the brackets can include a lens made of a transparent plastic part. And each one of the brackets can have at least one hole for housing or fitting a screw or a fastener in order to keep the brackets together.

Furthermore, generally, based on the teachings featured herein, another embodiment can be a method for assembling a set of light emitting diodes to form a light source assembly such as the ones described above. The method can include mounting the set of light emitting diodes on a substrate and securing the substrate with a set of brackets. At least one bracket in the set of brackets can include a lens configured to redirect light from at least one light emitting diode of the set of light emitting diodes. Furthermore, each bracket of the set of brackets can be made from a flexible material such that the whole light source assembly is flexible.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A light source assembly for use in a sign, comprising:
a plurality of light emitting diodes disposed on a substrate; and
a pair of brackets configured to secure the substrate,
wherein at least one of the pair of brackets includes a set of lenses where each lens overlaps with a light emitting diode of the plurality of light emitting diodes, and
wherein the substrate is mounted perpendicularly to a backing surface of the sign.

2. The light source assembly of claim 1, wherein the substrate is a printed circuit board.

3. The light source assembly of claim 1, wherein each one of the pair of brackets includes at least one hole.

4. The light source assembly of claim 3, wherein the at least one hole is configured to house at least one of a screw and a fastener.

5. The light source assembly of claim 1, wherein the pair of brackets form a “T” clip.

6. The light source assembly of claim 1, wherein at least one of the pair of brackets includes a portion made of transparent plastic.

7. The light source assembly of claim 6, wherein the portion is configured to redirect light from a light emitting diode of the plurality of light emitting diodes towards a direction normal to the backing surface.

8. A light source assembly for use with a sign, comprising:
a pair of brackets securing a substrate onto which there is mounted a set of light emitting diodes,
wherein at least one bracket of the pair of brackets includes a lens configured to redirect light from a light emitting diode of the set of light emitting diodes towards a diffusive surface of the sign disposed perpendicularly relative to the pair of brackets.

9. The light source assembly of claim 8, wherein the substrate is a flexible substrate.

10. The light source assembly of claim 8, wherein the substrate is a printed circuit board.

11. The light source assembly of claim 8, wherein the lens is made of a transparent plastic part.

12. The light source assembly of claim 8, wherein each one of the pair of brackets includes at least one hole.

13. The light source assembly of claim 12, wherein the at least one hole is configured to house at least one of a screw and a fastener.

14. A method for assembling a set of light emitting diodes in a sign, the method comprising:
mounting the set of light emitting diodes on a substrate;
securing the substrate with a set of brackets such that the substrate is perpendicular to a backing surface of the sign,
wherein at least one bracket in the set of brackets includes a lens configured to redirect light from at least one light emitting diode of the set of light emitting diodes to a diffusive surface of the sign disposed perpendicularly relative to the substrate.

15. The method of claim 14, wherein the substrate is a flexible substrate.

16. The method of claim 14, wherein the substrate is a printed circuit board.

17. The method of claim 14, wherein the lens is made from a transparent plastic part.

18. The method of claim 14, each bracket of the set of brackets includes at least one hole.

19. The method of claim 14, wherein the at least one hole is configured to house at least one of a screw and a fastener.

20. The method claim 14, wherein the each bracket of the set of bracket is made from a flexible material.
